(19) United States
(12) Patent Application Publication
(10) Pub. No.: US 2018/0292141 A1
(43) Pub. Date: Oct. 11, 2018

(54) HEAT EXCHANGER

(71) Applicant: LINDE AKTIENGESELLSCHAFT, MUNICH (DE)

(72) Inventors: Manfred Steinbauer, Raisting (DE); Christiane Kerber, Pöcking (DE); Markus Hammerdinger, Tacherting (DE); Jürgen Spreeman, Rosenheim (DE)

(73) Assignee: LINDE AKTIENGESELLSCHAFT, MUNICH (DE)

(21) Appl. No.: 15/951,365

(22) Filed: Apr. 12, 2018

Related U.S. Application Data
(62) Division of application No. 14/435,853, filed on Apr. 15, 2015, now abandoned.

(30) Foreign Application Priority Data
Oct. 18, 2012 (EP) 12007211.1

(51) Int. Cl. F28D 7/02; F28D 7/00; B23P 15/26

(52) U.S. Cl. CPC F28D 7/024; F28D 7/0083; F28D 2021/0059; Y10T 29/49352; B23P 15/26

(57) ABSTRACT

A helically coiled heat exchanger with a plurality of inlets each connected to at least one assigned tube defining a heating surface of the heat exchanger and having at least one changeover means to switch the inlet between a first operating state and a second operating state. In the first operating state, a stream of a first medium and, in the second operating state, a stream of a second medium is introduced via the inlet into the assigned tube. In the first operating state more heating surface is available to the stream of the first medium and correspondingly less heating surface is available to the stream of the second medium. In the second operating state more heating surface is available to the stream of the second medium and correspondingly less heating surface is available to the stream of the first medium.

The invention relates to a heat exchanger, in particular for the liquefaction of natural gas, or, for example, use in rectisol plants or petrochemical plants, and also to a method for adapting a heating surface of the heat exchanger to different operating situations.

Such a heat exchanger may carry one or more streams on the tube side. These tube-side streams are introduced via inlets of the heat exchanger into the heat exchanger and are distributed in each case to one or more tubes. The inlets are therefore distinctly assigned in each case to a stream.

If a heat exchanger is to be employed for sharply varying process-side loads, this means designing the heat exchanger for two or more operating situations. In most operating situations, the heating surfaces suitable for one situation are too small or too large for the streams in the next situation. The individual heating surface for one stream therefore has to be adapted to one situation and that for the other streams to other situations. This leads to considerable enlargement of the heat exchange surface and consequently also to markedly higher costs for the heat exchanger.

Proceeding from this, therefore, the subject on which the present invention is based is to improve a heat exchanger of the type mentioned in the introduction, to the effect that comparatively cost-effective adaptation to different operating situations is possible. Furthermore, the object on which the invention is based is to specify a corresponding method.

This problem is solved, on the one hand, by means of a helically coiled heat exchanger as described herein.

The helically coiled heat exchanger according to the invention has a plurality of inlets which are connected in each case to at least one assigned tube of the heat exchanger, so that at least one stream of a first medium and one stream of a second medium can be introduced via at least one assigned inlet in each case into the at least one tube assigned, the heat exchanger having a jacket surrounding a jacket space, in which the said tubes are arranged, so that, in particular, a stream of medium routed in the jacket space comes into indirect heat exchange with a stream of medium routed in the respective tube, and the said tubes being helically coiled in each case around a core tube of the heat exchanger.

According to the invention, then, there is provision whereby, to adapt the heating surface to different operating situations, the heat exchanger has at least one changeover means which is designed for switching to and fro or changing over at least one of the inlets between at least one first operating state and one second operating state, so that, in the first operating state, the stream or a substream of the first medium and, in the second operating state, the stream or a substream of the second medium can be introduced via the at least one inlet into the at least one assigned tube of the heat exchanger, in order, in the first operating state, to make more heating surface (to be precise, that of the at least one assigned tube) available to the stream of the first medium and to make correspondingly less heating surface available to the stream of the second medium, and in order, in the second operating state, to make more heating surface available to the stream of the second medium and to make correspondingly less heating surface available to the stream of the first medium.

The invention thus advantageously makes it possible to have the ability to changeover inlets (or corresponding connection pieces) and consequently the respectively assigned tubes and heating surfaces to the various tube-side streams. Thus, for example by means of the changeover, the heat exchange surface (also called heating surface) or part of the heat exchange surface of one medium can be made available to another medium. Thus, by the changeover, in particular, the heat exchange surface or heating surface is modified in that in each case a different number of tubes is allocated to the individual media.

Thus, for example, an embodiment is provided, in which, in a first operating situation, three inlets are available to the stream of the first medium and only one is available to the further stream of the second medium. For a second operating situation, however, the heating surface for the stream of the second medium will be larger and that for the stream of the first medium may be smaller. Correspondingly, for example, one of the three inlets for the stream of the first medium is then changed over to the stream of the second medium, and the heating surface coupled thereto is made available to the further stream of the second medium. The most diverse possible loads upon the streams for various situations can therefore be covered by means of a markedly smaller heating surface.

The invention can, of course, be applied to any number of a plurality of inlets or streams. In particular, a plurality of inlets may also be capable of being changed over in the way explained above or a plurality of changeover means may be provided. Moreover, one or more inlets may also be switched to and fro between more than two operating states or streams by means of a corresponding number of changeover means. Thus, for example, the at least one changeover means may be designed to switch at least one of the inlets to and fro between at least one first operating state and one second operating state, so that, in the first operating state, the stream or a substream of the first medium and, in the second operating state, the stream or a substream of the second medium can be introduced via the at least one inlet into the at least one assigned tube, so that, in the second operating state, one tube, a plurality of tubes or all tubes of the stream of the first medium are assigned to the stream of the second medium, so that correspondingly more heating surface is available to this and correspondingly less heating surface is available to the stream of the first medium.

In a further embodiment of the invention, there is provision whereby the changeover means for changing over the at least one inlet has a first valve for shutting off a first pipeline connected to that inlet and a second valve for shutting off a second pipeline connected to that inlet, the heat exchanger being designed to feed the stream of the first medium by the first pipeline and the stream of the second medium via the second pipeline to that inlet. If, for example, the second valve is closed and the first valve is open, only the stream of the first medium is delivered via the said inlet to the assigned tubes of the heat exchanger. In the event that the first valve is closed and the second valve is open, only the stream of the second medium is delivered via the said inlet to the assigned tubes of the heat exchanger.

An outlet, which is assigned to the respective inlet capable of being changed over and which is connected to the inlet via one or more tubes of the heat exchanger, likewise has a further changeover means, so that the outlet can be changed over correspondingly to the assigned inlet. For this purpose, the further changeover means may likewise have two valves, so that the stream drawn off in each case from the outlet can be fed to an assigned outlet pipeline.

Other devices, by means of which in each case one of a plurality of streams can be applied to an inlet or an outlet assigned to the inlet, may also be envisaged.

Preferably, the said inlets and/or the in each case assigned outlets are designed in each case as connection pieces for the heat exchanger. Such connection pieces preferably project from a pressure-carrying jacket of the heat exchanger, but may also be formed internally or be arranged in the jacket space. Moreover, the jacket surrounds a jacket space of the heat exchanger in which the said tubes of the heat exchanger are arranged, so that, in particular, a medium routed in the jacket space can come into indirect heat exchange with a medium routed in the respective tube.

Preferably, the respective inlet of the heat exchanger is connected to a plurality of assigned tubes, those tubes being anchored in a tube bottom assigned to the respective inlet or connection piece.

Especially preferably, as already mentioned, the heat exchanger according to the invention is designed as a helically coiled heat exchanger, in which the said tubes are in each case coiled, in particular, helically around the core tube of the heat exchanger, which core tube is arranged in the jacket space and extends, in particular, along a longitudinal axis of the jacket or heat exchanger, the said longitudinal axis coinciding with the vertical with respect to a heat exchanger which is arranged as intended. However, the heat exchanger could theoretically also be installed horizontally. It is also possible to apply the invention to other heat exchangers, such as, for example, straight-tube heat exchangers, plate heat exchangers or other heat exchangers.

The heat exchanger according to the invention is preferably used for the liquefaction of natural gas, in particular the changeover means being designed to changeover one of the inlets or connection pieces from a natural gas stream to a coolant stream, or vice versa. The heat exchanger according to the invention is not, of course, restricted to the use for the liquefaction of natural gas, but may also be employed, for example, in rectisol plants or petrochemical plants.

Furthermore, the problem on which the invention is based is solved by means of a method using the system as described.

Accordingly, there is provision whereby the heat exchanger has a plurality of inlets which are connected in each case to at least one assigned tube of the heat exchanger, each of the tubes which are assigned to the respective inlet defining a heating surface, at least one of the inlets being switched from a first operating state into a second operating state, so that, in the first operating state, the stream or a substream of the first medium and, in the second operating state, the stream of a substream of the second medium are introduced via the at least one inlet into the at least one assigned tube, in order, in the second operating state, to make more heating surface available to the stream of the second medium and to make correspondingly less heating surface available to the stream of the first medium.

Preferably, in the method according to the invention, the heat exchanger according to the invention is used.

Preferably, there is provision, furthermore, whereby, in the second operating state, one tube, a plurality of tubes or all tubes of the stream of the first medium is or are assigned to the stream of the second medium, so that correspondingly more heating surface is available to this and correspondingly less heating surface is available to the stream of the first medium (see also above).

### BRIEF DESCRIPTION OF DRAWINGS

Further details and advantages of the invention will be explained by means of the following figure descriptions of exemplary embodiments with reference to the figures in which:

FIG. 1 shows a diagrammatic sectional view of a heat exchanger according to the invention along a cross-sectional plane running transversally to the vertical or to the longitudinal axis of the heat exchanger.

FIG. 2 shows a diagrammatic, partially sectional view of an inlet capable of being changed over and of an assigned outlet capable of being changed over and also of a helical tube, connecting the inlet to the outlet, of a heat exchanger in the manner of FIG. 1.

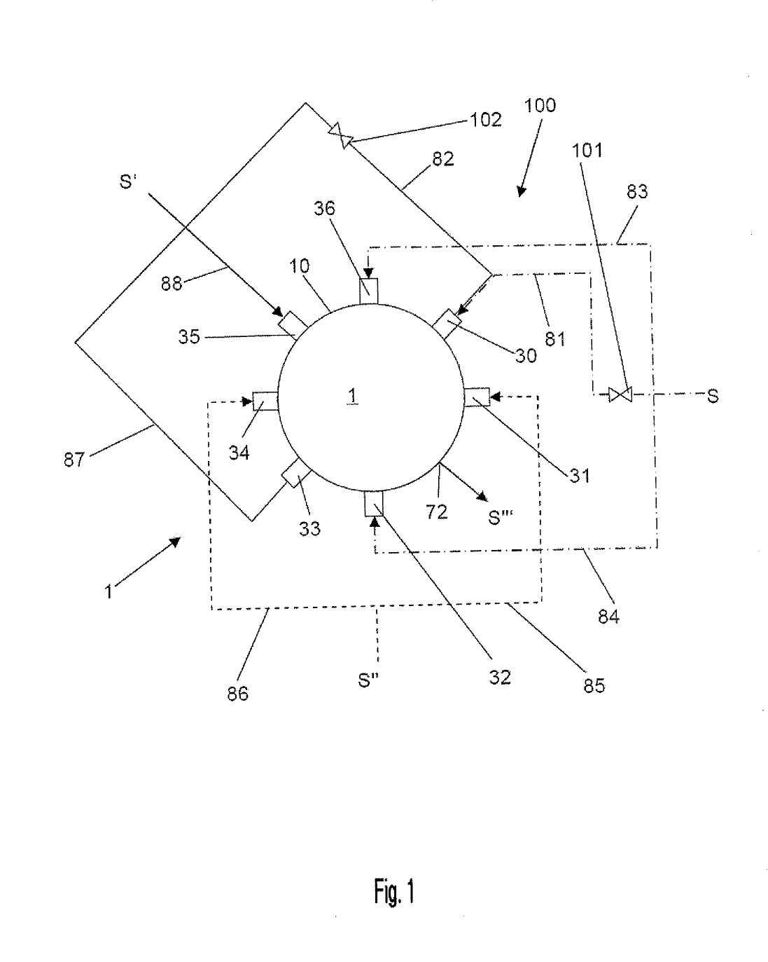

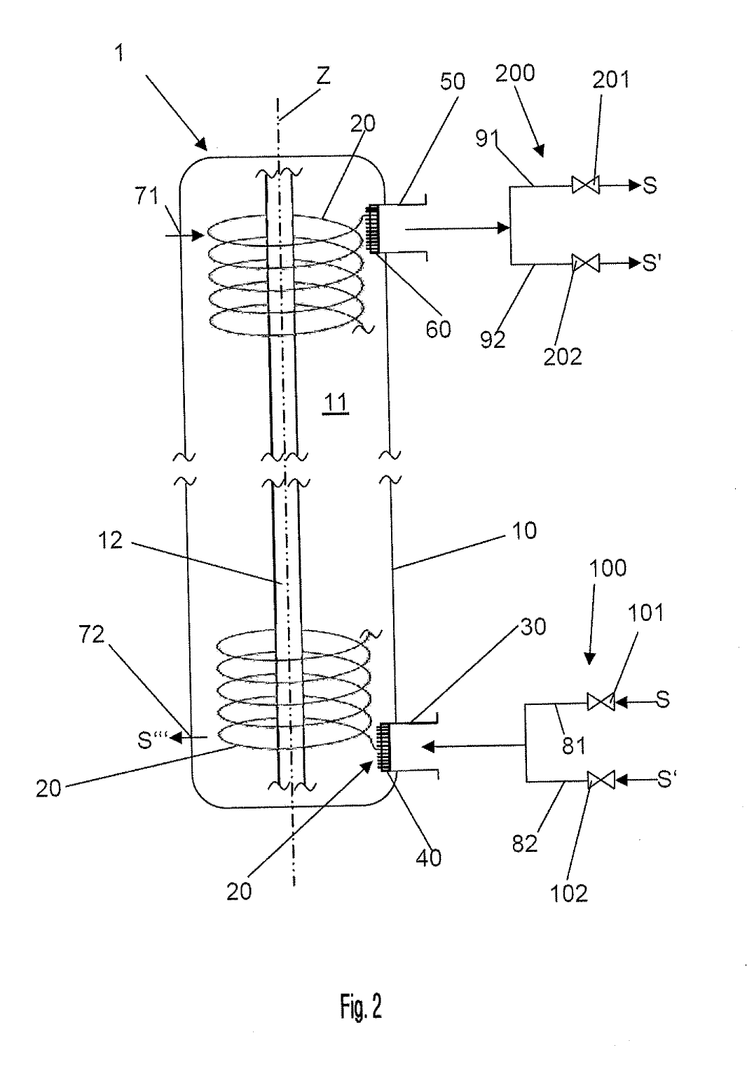

FIG. 1 shows, in conjunction with FIG. 2, a heat exchanger 1 according to the invention in the form of a helically coiled heat exchanger 1. The heat exchanger 1 has a pressure-carrying jacket 10, the longitudinal axis Z of which extends along the vertical Z. Alternatively to this, in a horizontal arrangement of the heat exchanger 1, the longitudinal axis Z may also run along the horizontal. The jacket 10 defines a jacket space 11, in which is arranged a core tube 12 which extends along the longitudinal axis Z, a plurality of tubes 20 being coiled helically in a plurality of layers around the core tube 12. For the sake of simplicity, only one such tube 20 is illustrated in FIG. 2. In each case a plurality of tubes 20 are anchored in an assigned tube bottom 40 and can be charged with a tube-side stream S, S′, S″ via an assigned inlet 30-36 in the form of a connection piece. For the sake of clarity, only one such connection piece 30 is depicted in FIG. 2. The tubes 20 extend from the respective inlet or connection piece 30-36, provided at the lower end of the jacket 10 of the heat exchanger 1, in the abovementioned way to an assigned outlet 50 in the form of a connection piece, one of which is illustrated by way of example in FIG. 2. Here, too, the individual tubes 20 are preferably combined in a tube bottom 60. The said inlets 30-36 may also be arranged at an upper region of the heat exchanger 1 and the assigned outlets 50 at a lower end; the tube-side flow then runs from the top downwards and the jacket-side flow from the bottom upwards.

Furthermore, in the jacket space 11, a jacket-side stream S′″ is routed in countercurrent to the tube-side streams S, S′, S″, is introduced into the jacket space 11 via an inlet 71 and is drawn off from the jacket space 11 via an outlet 72. The individual tube-side streams S, S′, S″ in this case come into indirect heat exchange with one another and with the jacket-side stream S′″.

According to FIG. 1, the heat exchanger 1 has, in particular, tree connection pieces 30, 32, 36 which are connected to pipelines 81, 82, 83 and 84, a stream S of a first medium being introduced via the pipelines 81, 83 and 84 in each case into a plurality of tubes 20 of the heat exchanger 1 which are connected to the connection pieces 30, 32, 36. Moreover, the heat exchanger 1 has two connection pieces 35, 33 which are connected to pipelines 87, 88, via which a stream S′ of a second medium is introduced in each case into a plurality of tubes 20 connected to the connection pieces 33, 35, and, furthermore, two connection pieces 31, 34 which are connected to pipelines 85, 86, via which a stream S″ of a third medium is fed in each case into a plurality of tubes 20 of the heat exchanger 1 which are connected to the connection pieces 31, 34.

In order, then, to be able to adapt the individual heating surfaces, defined by the tubes 20, of the heat exchanger 1 to different operating situations, according to the invention at least one of the inlets or connection pieces 30 is configured to be capable of being changed over, that is to say, in the present case, via the said connection piece 30, in a first operating state, either the stream S of the first medium or, in a second operating state, the stream S′ of the second medium can be fed into the connection piece 30. The available heating surface can thereby be apportioned to the existing tube-side stream S, S′. Thus, in natural gas liquefaction, depending on the operating situation, for example, more heating surface can be assigned to the natural gas stream S to be liquefied or to the heavy coolant mixture stream S′ (and correspondingly less heating surface can be assigned in each case to the other stream).

The changeover of the connection piece 30 may be implemented, for example, in that the first pipeline 81 carrying the stream S of the first medium and connected to the connection piece 30 has a first valve 101, and in that the second pipeline 82 carrying the stream S′ of the second medium and connected to the connection piece 30 has a second valve 102. According to the position of the valves 101, 102, either the one or the other stream S, S′ can then be fed into the connection piece 30.

A further changeover means 200 is provided for the outlet 50 assigned to the connection piece 30 (cf. FIG. 2), so that the stream S, S′ drawn off in each case from the assigned outlet 50 can be fed into an assigned outlet pipeline 91, 92. For the correct distribution of the streams S, S′ to the outlet pipelines 91, 92, the further changeover means 200 may have a first valve 201 on the first outlet pipeline 91 and a second valve 202 on the second outlet pipeline 92.

The above-described principle according to the invention, can, of course, be applied to all existing tube-side streams or inlets and in each case assigned outlets.

By means of the invention, therefore, the most diverse possible load situations for different tube fractions can be covered, without the heating surface being enlarged. The costs for the heat exchanger are thereby lowered and its flexibility is increased considerably.

### LIST OF REFERENCE SYMBOLS

| | |
|---|---|
| 1 | Helically coiled heat exchanger |
| 10 | Jacket |
| 11 | Jacket space |
| 12 | Core tube |
| 20 | Tube |
| 30-36 | Inlets or connection pieces |
| 40, 60 | Tube bottom |
| 50 | Outlet or connection piece |
| 71 | Inlet jacket space |
| 72 | Outlet jacket space |
| 80-88 | Pipelines |
| 100 | Changeover means |
| 101, 102, 201, 202 | Valves |
| 200 | Further changeover means |
| S | Stream of first medium |
| S′ | Stream of second medium |
| S″ | Stream of third medium |
| S′″ | Jacket-side stream |
| Z | Longitudinal axis, vertical |

1-9. (canceled)

10. A method of operating Method for adapting the heating surface of a helically coiled heat exchanger to adjust to different operating situations, said heat exchanger having a plurality of tubes and a plurality of inlets wherein each of said inlets is connected to at least one of said tubes of the heat exchanger, each of the tubes defining a heating surface, said method comprising:
switching, via at least one changeover means, at least one of the inlets from a first operating state to into a second operating state, wherein, in said first operating state, a stream of a first medium is introduced via said at least one inlet into said at least one of said tubes, and, in said second operating state, a stream of a second medium is introduced via said at least one inlet into said at least one of said tubes, wherein, as a result of said switching heating surface is available for the stream of the second medium, in the second operating state, and, correspondingly, less heating surface is available for the stream of the first medium.

11. The method according to claim 10, wherein only one inlet is switched from said first operating state to said second operating state.

12. The method according to claim 10, wherein a plurality of said inlets is switched from said first operating state to said second operating state.

13. The method according to claim 10, wherein all of said inlets are switched from said first operating state to said second operating state.

14. The method according to claim 10, wherein the changeover means has a first valve for shutting off a first pipeline connected to the at least one inlet and a second valve for shutting off a second pipeline connected to the at least one inlet, wherein the stream of the first medium is supplied to said at least one inlet via said first pipeline, and the stream of the second medium is supplied to said at least one inlet via said second pipeline.

15. The method according to claim 10, wherein said heat exchanger further comprises a plurality of outlets wherein each of said outlets is connected to at least one of said tubes, and
said method further comprising switching, via at least one further changeover means, at least one of the outlets from the first operating state to the second operating state, wherein, in the first operating state, a stream of the first medium can be removed from said at least one of said tubes via said at least one outlet, and, in the second operating state, a stream the second medium can be removed from said at least one of said tubes via said at least one outlet.

16. The method according to claim 15, wherein the further changeover means has a first valve for shutting off a first outlet pipeline connected to the at least one outlet and a second valve for shutting off a second outlet pipeline connected to the at least one outlet, wherein the stream of the first medium is supplied from said at least one outlet to said first outlet pipeline, and the stream of the second medium is supplied from said at least one inlet to said second outlet pipeline.

17. The method according to claim 10, wherein said inlets are arranged at an upper end or at a lower end of said heat exchanger.

18. The method according to claim 17, wherein said outlets are arranged at an end of said heat exchanger which is opposite to the end where said inlets are arranged.

19. The method according to claim 18, wherein said heat exchanger has a jacket surrounding said tubes and said inlets and/or said outlets project from the jacket.

20. The method according to claim 10, wherein said tubes are anchored by an inlet tube bottom.

21. The method according to claim 10, wherein said tubes are anchored by an outlet tube bottom.

22. The method according to claim 10, wherein a plurality of said tubes are connected to one of said inlets so that the plurality of said tubes can be switched from said first operating state to said second operating state.

23. The method according to claim 22, wherein said plurality of said tubes is also connected to one of said outlets.
